(19) United States
(12) Patent Application Publication
(10) Pub. No.: US 2006/0168820 A1
(43) Pub. Date: Aug. 3, 2006

(54) Brick pliers saving manual work

(75) Inventor: Timmy Chen, Taichung City (TW)

Correspondence Address: NIKOLAI & MERSEREAU, P.A., 900 SECOND AVENUE SOUTH, SUITE 820, MINNEAPOLIS, MN, 55402, US

(73) Assignee: PLUS CRAFT INDUSTRIAL CO., LTD, Taichung City (TW)

(21) Appl. No.: 11/048,162

(22) Filed: Feb. 1, 2005

(51) Int. Cl. B26B 17/00

(52) U.S. Cl. 30/175

(57) ABSTRACT

A pair of pliers includes two handles, two opposite connecting plates each pivotally mounted on the two handles, a limit post located between the two handles and encompassed by the two connecting plates, and two pivot shafts each extended through the two connecting plates and a respective one of the two handles so that the two handles are pivotally connected with the two connecting plates. Thus, the distance between the spring and the limit post is increased, so that the movement distance of the force arm of each of the two handles is increased, thereby saving the user's manual work.

### BACKGROUND OF THE INVENTION

1. Field of the Invention

The present invention relates to a pair of pliers, and more particularly to a pair of pliers that saves the manual work.

2. Description of the Related Art

A pair of conventional pliers 1 in accordance with the prior art shown in FIGS. 4 and 5 comprises two handles 11 pivotally connected by a rivet 14, and a spring 13 biased between the two handles 11. Each of the two handles 11 has a first end provided with a cutting blade 112 and a second end provided with a retaining rod 111, and the spring has two ends each mounted on the retaining rod 111 of a respective one of the two handles 11. In operation, when the two handles 11 are moved toward each other, the two handles 11 are pivoted about the rivet 14, so that the cutting blades 112 of the two handles 11 are moved toward each other to cut a brick 2. At this time, the rivet 14 functions as a fulcrum of the cutting blades 112 of the two handles 11 during the cutting action. However, the distance between the rivet 14 and the spring 13 is relatively smaller, so that the distance of the applying force of the pliers is relatively smaller, thereby wasting the manual work when holding the pliers to cut the brick 2. In addition, the cutting blades 112 of the two handles 11 are supported by the rivet 14 during the cutting action, thereby decreasing the cutting effect of the pliers.

### SUMMARY OF THE INVENTION

In accordance with the present invention, there is provided a pair of pliers, comprising: two handles; two opposite connecting plates each pivotally mounted on the two handles; and a limit post located between the two handles and encompassed by the two connecting plates.

The primary objective of the present invention is to provide a pair of pliers that saves the manual work.

Another objective of the present invention is to provide a pair of pliers, wherein the distance between the spring and the limit post is increased, so that the movement distance of the force arm of each of the two handles is increased, thereby saving the user's manual work.

A further objective of the present invention is to provide a pair of pliers, wherein the cutting blades of the two handles are pivoted and supported by the two connecting plates during the brick cutting action to absorb and reduce the resistance applied by the brick, thereby enhancing the cutting effect of the cutting blades of the two handles.

A further objective of the present invention is to provide a pair of pliers, wherein the limit post functions as a fulcrum of the cutting blades of the two handles to reduce the force applied on the cutting blades of the two handles, thereby facilitating the user cutting the brick in an energy-saving manner.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a pair of pliers in accordance with the preferred embodiment of the present invention;

FIG. 2 is an exploded perspective view of the pliers as shown in FIG. 1;

FIG. 3 is a top plan operational view of the pliers as shown in FIG. 1;

FIG. 4 is a perspective view of a pair of conventional pliers in accordance with the prior art; and

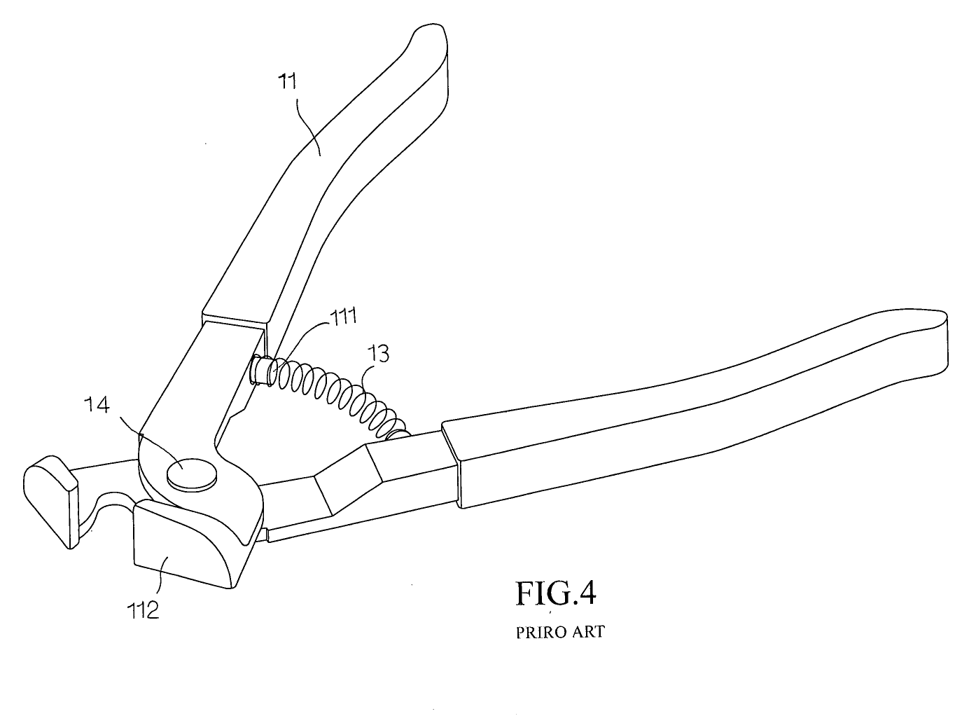

FIG. 5 is a top plan operational view of the conventional pliers as shown in FIG. 4.

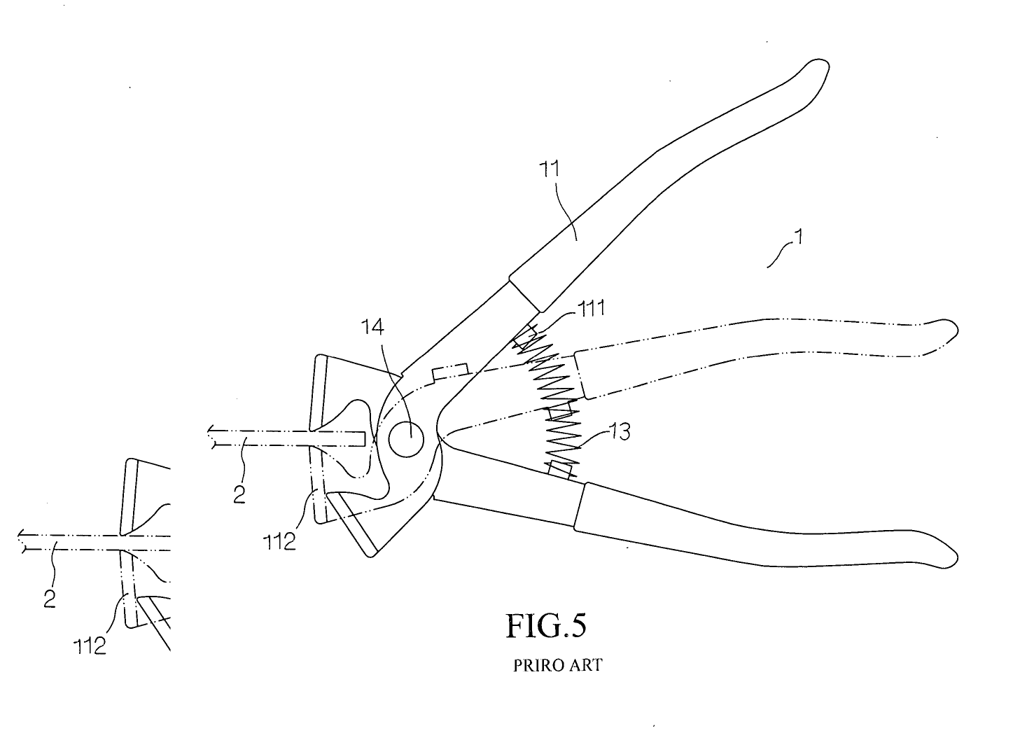

### DETAILED DESCRIPTION OF THE INVENTION

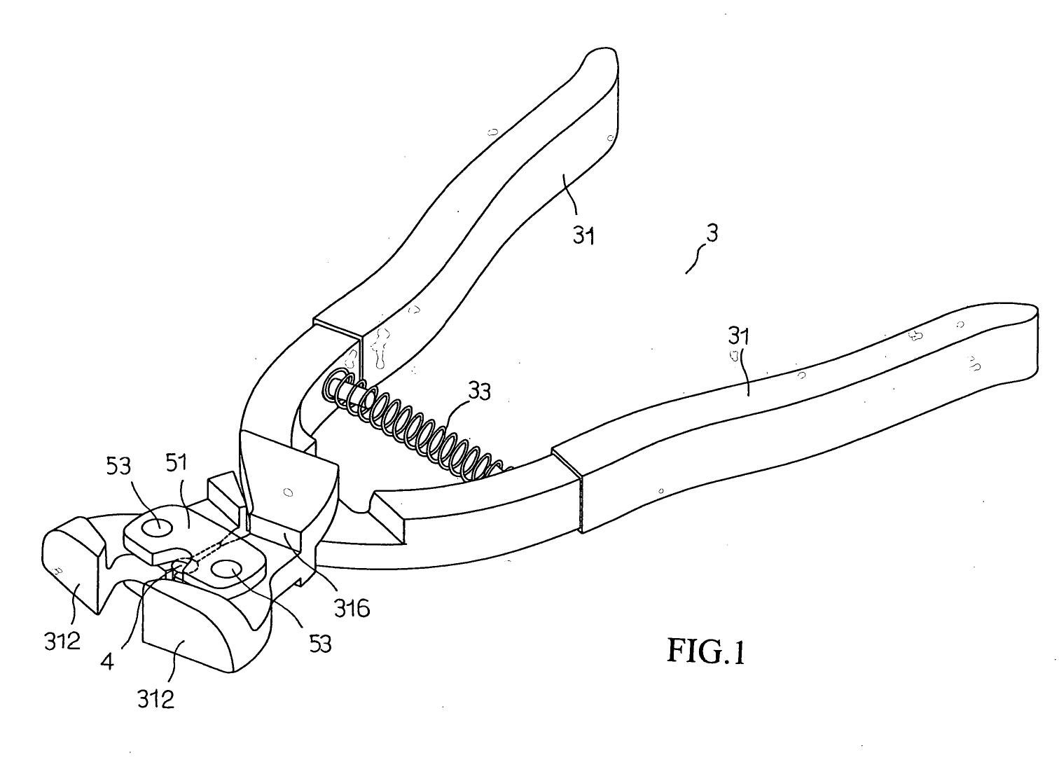

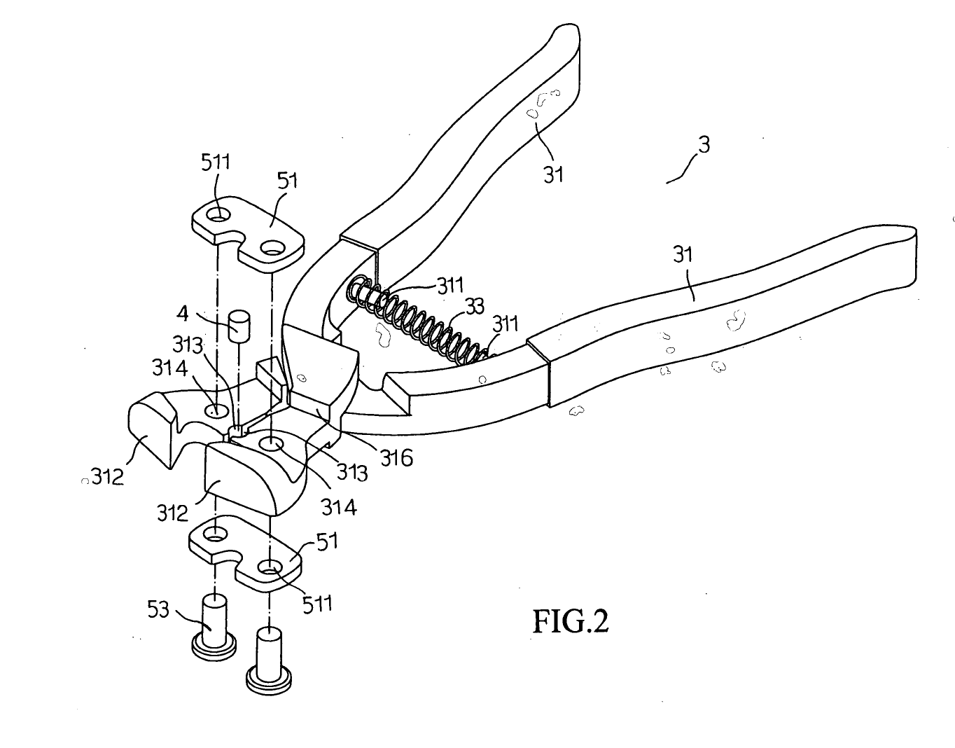

Referring to the drawings and initially to FIGS. 1 and 2, a pair of pliers 3 in accordance with the preferred embodiment of the present invention comprises two handles 31, two opposite connecting plates 51 each pivotally mounted on the two handles 31, a limit post 4 located between the two handles 31 and encompassed by the two connecting plates 51, and two pivot shafts 53 each extended through the two connecting plates 51 and a respective one of the two handles 31 so that the two handles 31 are pivotally connected with the two connecting plates 51.

Each of the two handles 31 has a first end provided with a cutting blade 312 and a second end provided with a retaining rod 311. A spring 33 is biased between the two handles 31 and has two ends each mounted on the retaining rod 311 of a respective one of the two handles 31. Each of the two handles 31 has a mediate portion rested on the limit post 4 and having a side formed with a semi-circular limit recess 313 located adjacent to the respective cutting blade 312 to receive the limit post 4. The mediate portion of each of the two handles 31 is formed with a pivot hole 314. The mediate portion of each of the two handles 31 has two opposite faces each formed with a receiving space 316 to receive a respective one of the two connecting plates 51.

Each of the two connecting plates 51 is rested on a face (top face or bottom face) of each of the two handles 31 to cover and limit a distal end of the limit post 4 and has two ends each pivotally mounted on a respective one of the two handles 31. Each of the two ends of each of the two connecting plates 51 is formed with a pivot hole 511.

Each of the two pivot shafts 53 is extended through the respective pivot hole 511 of each of the two connecting plates 51 and the pivot hole 314 of a respective one of the two handles 31.

In operation, referring to FIGS. 1-3, when the two handles 31 are moved toward each other, the two handles 31 are pivoted about the two pivot shafts 53 relative to the two connecting plates 51, so that the cutting blades 312 of the two handles 31 are moved toward each other to cut a brick 6. At this time, the two handles 31 are pivoted by limit of the limit post 4 and linkage of the two connecting plates 51.

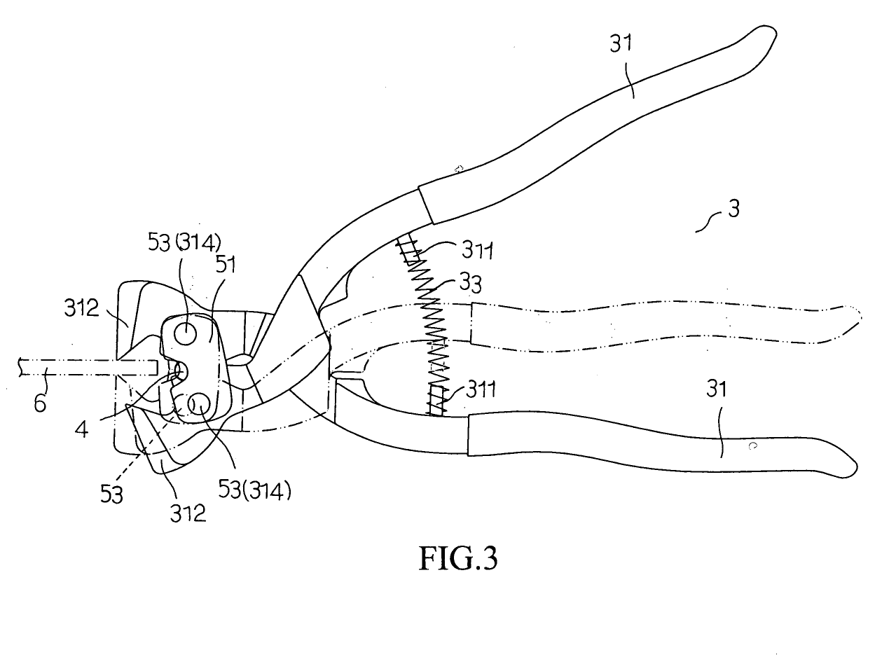

When the two handles 31 are moved toward each other as shown in FIG. 3, one of the two pivot shafts 53 is pushed forward to move one end of each of the two connecting plates 51 forward to push the limit post 4 forward so as to increase the distance between the spring 33 and the limit post 4. Thus, the movement distance of the force arm of each of the two handles 31 is increased, thereby saving the manual work. In addition, the cutting blades 312 of the two handles 31 are pivoted and supported by the two connecting plates 51 during the cutting action to absorb the resistance from the brick 60, thereby enhancing the cutting effect of the cutting blades 312 of the two handles 31.

Accordingly, the distance between the spring 33 and the limit post 4 is increased, so that the movement distance of the force arm of each of the two handles 31 is increased, thereby saving the user's manual work. In addition, the cutting blades 312 of the two handles 31 are pivoted and supported by the two connecting plates 51 during the brick cutting action to absorb and reduce the resistance applied by the brick 60, thereby enhancing the cutting effect of the cutting blades 312 of the two handles 31. Further, the limit post 4 functions as a fulcrum of the cutting blades 312 of the two handles 31 to reduce the force applied on the cutting blades 312 of the two handles 31, thereby facilitating the user cutting the brick 60 in an energy-saving manner.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A pair of pliers, comprising:
two handles;
two opposite connecting plates each pivotally mounted on the two handles;
a limit post located between the two handles and encompassed by the two connecting plates.

2. The pliers in accordance with claim 1, wherein each of the two handles has a mediate portion rested on the limit post.

3. The pliers in accordance with claim 2, wherein the mediate portion of each of the two handles has a side formed with a limit recess to receive the limit post.

4. The pliers in accordance with claim 3, wherein the limit recess of each of the two handles is semi-circular.

5. The pliers in accordance with claim 3, wherein each of the two handles has a first end provided with a cutting blade, and the limit recess of each of the two handles is located adjacent to the respective cutting blade.

6. The pliers in accordance with claim 5, wherein each of the two handles has a second end, and the pliers further comprises a spring biased between the second ends of the two handles.

7. The pliers in accordance with claim 6, wherein a distance between the spring and the limit post is relatively increased, so that a movement distance of the force arm of each of the two handles is relatively increased.

8. The pliers in accordance with claim 2, wherein the mediate portion of each of the two handles has two opposite faces each formed with a receiving space to receive a respective one of the two connecting plates.

9. The pliers in accordance with claim 1, further comprising two pivot shafts each extended through the two connecting plates and a respective one of the two handles so that the two handles are pivotally connected with the two connecting plates.

10. The pliers in accordance with claim 9, wherein each of the two handles is formed with a pivot hole, each of the two connecting plates has two ends each formed with a pivot hole, and each of the two pivot shafts is extended through the respective pivot hole of each of the two connecting plates and the pivot hole of a respective one of the two handles.

11. The pliers in accordance with claim 9, wherein when the two handles are moved toward each other, one of the two pivot shafts is pushed forward to move one end of each of the two connecting plates forward to push the limit post forward so as to relatively increase a distance between the spring and the limit post.

12. The pliers in accordance with claim 9, wherein when the two handles are moved toward each other, the two handles are pivoted about the two pivot shafts relative to the two connecting plates.

13. The pliers in accordance with claim 1, wherein each of the two connecting plates is rested on a face of each of the two handles to cover and limit a distal end of the limit post.

14. The pliers in accordance with claim 1, wherein each of the two connecting plates has two ends each pivotally mounted on a respective one of the two handles.

15. The pliers in accordance with claim 1, wherein the two handles are pivoted by limit of the limit post and linkage of the two connecting plates.

16. The pliers in accordance with claim 5, wherein the cutting blades of the two handles are pivoted and supported by the two connecting plates.

17. The pliers in accordance with claim 5, wherein the limit post functions as a fulcrum of the cutting blades of the two handles.
